(19) United States
(12) Patent Application Publication
(10) Pub. No.: US 2007/0078939 A1
(43) Pub. Date: Apr. 5, 2007

(54) Method and apparatus for identifying and classifying network documents as spam

(75) Inventor: Ian Kallen, Lafayette, CA (US)

Correspondence Address: BEYER WEAVER LLP, P.O. BOX 70250, OAKLAND, CA, 94612-0250, US

(73) Assignee: Technorati, Inc.

(21) Appl. No.: 11/527,765

(22) Filed: Sep. 25, 2006

Related U.S. Application Data
(60) Provisional application No. 60/720,918, filed on Sep. 26, 2005.

(51) Int. Cl. G06F 15/16

(52) U.S. Cl. 709/207

(57) ABSTRACT

Disclosed are methods and apparatus, including computer program products, implementing and using techniques for methods and apparatus, including computer program products, implementing and using techniques for identifying and classifying a network document as a spam candidate. In one aspect of the present invention, a network document is retrieved. Affiliate identification information is identified in the network document. One or more publications are associated with the identified affiliate identification information. Publication data for the network document is determined according to the identified affiliate identification information and the identified one or more publications. When it is determined that the publication data satisfies a condition indicative of spam, the network document is classified as a spam candidate.

### RELATED APPLICATION DATA

The present application claims priority under 35 U.S.C. § 119(e) to U.S. Provisional Patent Application No. 60/720,918, for METHOD FOR CLASSIFYING WEB PAGE SPAM BEARING AFFILIATE IDENTIFICATION TOKENS, filed on Sep. 26, 2005 (Attorney Docket No. TECHP006P), which is hereby incorporated by reference for all purposes.

### FIELD OF THE INVENTION

The present invention relates generally to techniques for analyzing network documents to identify deceptively published content or “web spam.” More particularly, the present invention provides schemes for monitoring and processing documents such as web pages to identify misleading publication activity and illegitimate content, indicative of web spam.

### BACKGROUND OF THE INVENTION

The World Wide Web provides the platform for modem wide area E-commerce activities. Online advertisers conducting advertisement and sales activity on the web are motivated to identify popular web pages or sites and display advertisements on those pages to reach as many potential customers as possible. To this end, advertisers often enter into relationships with ad network service providers, such as Amazon's Associates and Google's AdSense. In a typical arrangement, the ad network service provider will interface with and distribute the advertisements to a variety of publishers of web pages and/or sites.

FIG. 1 shows a conventional online advertising system 100 implemented on a data network 104 such as the Internet. In FIG. 1, system 100 includes an ad network service provider 102 in communication with data network 104. The system 100 further includes a plurality of publishers 1-n, designated by reference numerals 106, 108, and 110, an advertiser 112, and an Internet search engine 116, all in communication with data network 104.

A “publisher,” as used herein, refers to any provider of a web page or site implemented on a network server or other suitable data processing device capable of displaying advertisements on electronic documents accessible over the network. An “advertiser,” as used herein, refers to any advertiser operating a personal computer, server, or other suitable data processing device in communication with the network. Often, electronic advertisements provided on publisher web pages provide direct or indirect links to the advertiser's web site. For instance, an indirect link can redirect a user click to a URL that tracks the click event before linking to an advertiser's page. A user 114 operates a data processing device such as a personal computer, laptop computer, PDA, or cell phone, having a web browser program or other suitable Internet navigation software, in communication with data network 104. When user 114 clicks on a published ad, the user's browsing program is routed to an advertiser web page or site associated with the ad.

In a typical online advertising arrangement, advertiser 112 enters into a contract with ad network service provider 102 to display ads on third party sites, such as publishers 106, 108, and 110. In the contract, ad network service provider 102 facilitates the distribution of advertiser 112 advertisements to one or more of publishers 106, 108, and 110, in exchange for advertiser 112 paying ad network service provider 102 a finder's fee or “bounty” for customers that access an advertiser 112 web site or page responsive to the ads. In one example, the contract specifies a pay-per-click (PPC) arrangement, in which advertiser 112 pays ad network service provider 102 a fee for every click on a publisher web page that is routed to advertiser 112. For instance, advertiser 112 may pay ad network service provider 102 a fee of $1.00 per click which links to the advertiser's web page or site.

In the arrangement described above, advertiser 112 earns revenue by converting the lead, i.e. the click, into a sale, or by charging a third party seller for the action. The ad network service provider 102 earns revenue in the form of bounty payments per click and/or per sale from advertiser 112. The publishers 106, 108, and 110 often have their own arrangements with ad network service provider 102. In a typical arrangement, ad network service provider 102 shares a portion of its bounty payment revenues, received from advertiser 112, with the publishers. Hence, the more visitors to a publisher's web site bearing bounty-paying links, the more revenue potential exists for the publisher.

In a PPC arrangement in which ad network service provider 102 shares revenue derived from advertiser 112 with the publisher displaying the advertiser's ad, the publisher is motivated to display its ad-bearing pages to as many users as possible. This motivation increases when advertisers pay larger per-click fees to ad network service provider 102, resulting in increased shares of those fees for the publisher providing the link to advertiser 112. One way that publishers can increase the frequency and total number of visits to their web pages, thereby putting their bounty-paying links in front of more users, is to rank highly in search results on a popular search engine 116 such as Google or Yahoo.

Web site ranking on a search engine can be manipulated by deceptive and misleading practices to give the publisher web site a higher ranking among other web sites, and/or to influence the category to which the web site is assigned. These deceitful practices abuse the conventional algorithms, ranking, and categorization techniques employed by search engines to give a page a ranking or classification it does not deserve. Such practices are often referred to as “spamdexing,” “spamming,” “search engine spamming,” and “web page spamming.” One spamming technique involves manipulating the content published on web pages. The content of manipulated web pages made for spamming purposes is generally not useful or even relevant to the ordinary user attempting to conduct a good faith search on the search engine 1 16. Such illegitimate content and illegitimate pages are often referred to as “spam.”

Web page spam and spamming techniques can arise in a variety of forms, all of which are manipulative and deceptive, done solely for the purpose of affecting the page's rank or classification on a search engine. The frequency of publication of the illegitimate web pages can be increased. A misleading number of inbound links, or citations, to the illegitimate web pages can be published on other web pages. Also, the publisher of the illegitimate web page can intentionally overuse and misuse specific keywords and focused terminology in the web page content.

Search engine ranking and classification algorithms are typically structured to rank recently published pages higher than other pages otherwise having the same relevancy and citation scores. Thus, publishing early and often is a common practice among web page spammers in order to give the appearance of being a publisher of legitimate content. Creating legitimate, that is, original and authentic, content is a time consuming creative process. However, abusers can fraudulently attain the appearance of legitimacy by publishing illegitimate pages frequently, for instance, by automatically publishing third party content. This deceptive practice gives the appearance of web site activity and relevance.

The appearance of higher external interest in an illegitimate web page is specifically intended to manipulate search engine ranking. A web page spammer can generate inflated citations by providing a large directed graph of links to the target illegitimate web page to manipulate the inbound link count, often referred to as “link farming.” These links can be provided on a group of other fraudulent web pages sites, referred to as “link farms.” Each node in the graph contributes to the appearance of higher external interest in the target web pages' content. A page's rank is also influenced by how many citations the search engine finds that link to the fraudulent web sites, defining a level of authority for each fraudulent web site. To compensate for the absence of authority for the nodes in the manufactured web graph, an abuser will often produce nodes on a vastly exaggerated scale.

Web site ranking can also be manipulated by search term relevance. Web page spammers can “stuff” the text of their illegitimate web pages with keywords as a ruse to trick search engines. Stuffed text may generate a match in a search engine's decomposition of a web page without necessarily contributing to the web page content or narrative. Other factors may include the position of the terms within a document or where among a document's structural elements the terms appear.

What are needed are techniques for analyzing the publication of network documents such as web pages to identify misleading content and activity. In this way, web page spam and spamming activity can be recognized and dealt with accordingly.

### SUMMARY OF THE INVENTION

Aspects of the present invention relate to methods and apparatus, including computer program products, implementing and using techniques for identifying and classifying a network document as a spam candidate. In one aspect of the present invention, a network document is retrieved. Affiliate identification information is identified in the network document. One or more publications are associated with the identified affiliate identification information. Publication data for the network document is determined according to the identified affiliate identification information and the identified one or more publications. When it is determined that the publication data satisfies a condition indicative of spam, the network document is classified as a spam candidate.

In another aspect of the present invention, a data processing device is configured for identifying and classifying a network document as a spam candidate. The data processing device includes a communications interface capable of receiving the network document over a data network, and a processor coupled to the communications interface. The processor is operatively coupled to: i) identify affiliate identification information in the network document; ii) identify one or more publications associated with the identified affiliate identification information; iii) determine publication data for the network document according to the identified affiliate identification information and the identified one or more publications; iv) determine that the publication data satisfies a condition indicative of spam; and v) when it is determined that the publication data satisfies the condition, classify the network document as a spam candidate.

A further understanding of the nature and advantages of the present invention may be realized by reference to the remaining portions of the specification and the drawings.

### BRIEF DESCRIPTION OF THE DRAWINGS

FIG. 1 shows a block diagram of a conventional online advertising system 100 implemented on a data network.

FIG. 2 shows a block diagram of a system 200 for identifying and classifying network documents as spam, constructed according to one embodiment of the present invention.

FIG. 3 shows a flow diagram of a network document filtering method 300, performed in accordance with one embodiment of the present invention.

FIGS. 4A, 4B, 4C, 4D, and 4E show illustrations of data structures in the form of tables of network document publication data maintained by a spam identification engine, constructed according to embodiments of the present invention.

FIG. 5 shows a flow diagram of a publication-based method 500 of identifying and classifying network documents as spam, performed in accordance with one embodiment of the present invention.

FIG. 6 shows a flow diagram of a content-based method 600 of identifying and classifying network documents as spam, performed in accordance with one embodiment of the present invention.

### DETAILED DESCRIPTION OF SPECIFIC EMBODIMENTS

Reference will now be made in detail to specific embodiments of the invention including the best modes contemplated by the inventors for carrying out the invention. Examples of these specific embodiments are illustrated in the accompanying drawings. While the invention is described in conjunction with these specific embodiments, it will be understood that it is not intended to limit the invention to the described embodiments. On the contrary, it is intended to cover alternatives, modifications, and equivalents as may be included within the spirit and scope of the invention as defined by the appended claims. In the following description, specific details are set forth in order to provide a thorough understanding of the present invention. The present invention may be practiced without some or all of these specific details. In addition, well-known features may not have been described in detail to avoid unnecessarily obscuring the invention.

Substantial accumulated citations, recurrent publishing, and focused terminology are all characteristics of high quality search results. However, to score among the highly ranked legitimate web pages that have developed these characteristics organically, spammers seek to manifest these ingredients within a compressed timeframe to compensate for an otherwise poor ranking relative to legitimate web pages. Embodiments of the invention are intended to identify such illegitimate and abusively created content, often created as a result of automated and frequent web page publishes. Embodiments of the invention provide identification, ranking, and classification of documents available in a data network for spam characteristics. Links and other structural elements of a document can be identified that indicate commercially motivated and deceptive publishing activities.

Embodiments of the present invention provide for correlating publish activity rates with affiliate identification information. For instance, web pages can be correlated with web spammers by identifying affiliate identification information, such as a token, embedded in the page structure source code. Documents can be classified as spam candidates based on measurements of publishing activity, such as content change frequency, with the identified links and other structural elements. Search engines that programmatically survey (or crawl) the World Wide Web traditionally examine each document's text, structure and links for indexing, classification and other types of organization. Embodiments of the present invention expand upon the capabilities of a search engine to include affiliate network identification token extraction, and denial of the benefit of organizing the content based on tokens that are identified as associated with web page spam.

To identify spam, embodiments of the present invention examine the structure of a network document for indications of affiliation with commercial bounty paying click networks. Statistics on the publish cycle timeframe and the dispersion across publications of affiliate identification tokens can be used to flag web pages as spam.

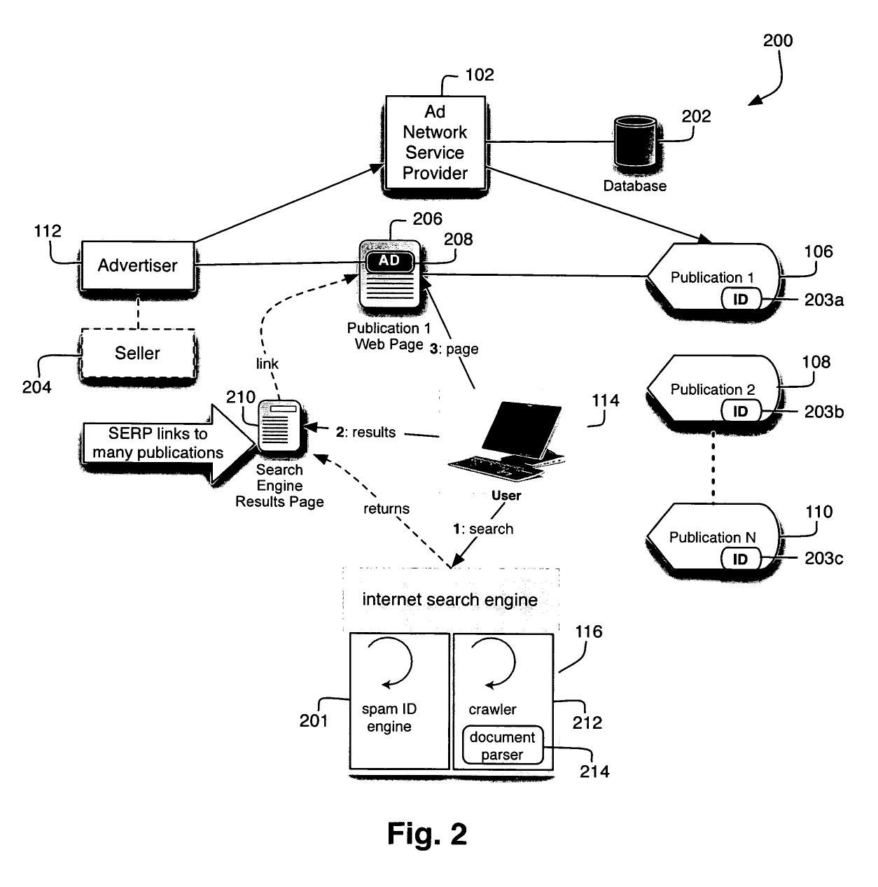

FIG. 2 shows a block diagram of a system 200 for identifying and classifying network documents as spam, constructed according to one embodiment of the present invention. System 200 shares some of the same devices and components of the conventional advertising system 100, as designated by like reference numerals. System 200, however, further includes a spam identification engine 201 in communication with data network 104 and operatively coupled to perform network document filtering, network document publication data gathering and processing, and spam identification and classification techniques described herein. Spam identification engine 201 can be integrated as one component of search engine 116, with a separate crawler component 212 providing traditional Internet search and classification methods. Crawler component 212 often includes a document parser process 214, as shown in FIG. 2. Spam identification engine 201 can be integrated separately or in combination with crawler 212 on one or more suitable servers, personal computers, portable data processing devices such as a laptop computer or PDA, or some combination of data processing devices. Spam identification engine 201 can be coupled to data network 104 by a wired or wireless connection, as should be appreciated by those skilled in the art.

Often, as part of the contract between advertiser 112 and ad network service provider 102, advertiser 112 provides ad network service provider 102 with electronic advertisements, or simply advertisement information that ad network service provider 102 uses to construct electronic advertisements. Such advertisement information and data can be maintained by ad network service provider 102 in a suitable storage medium 202, such as a database, and organized so that advertisement information or data provided by advertiser 112 is searchable and identifiable for easy retrieval by ad network service provider 102.

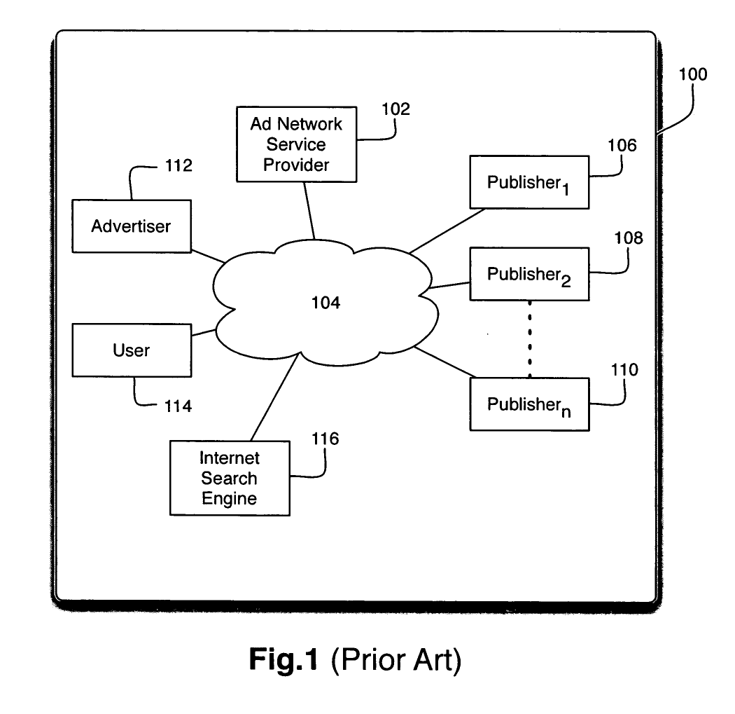

FIG. 2 shows a plurality of publications 106a, 108a, and 110a, such as web pages or other suitable network documents. In one embodiment, each publication 106a, 108a, and 110a, is associated with a respective publisher 106, 108, and 110, of FIG. 1. In FIG. 2, each publication 106a, 108a, and 110a has a respective publication ID 203a, 203b, and 203c. The publication ID is an assigned handle, which uniquely identifies the publication.

Generally, there are at least four ways in which ads and affiliate identification information are inserted into web pages. These include: 1) direct dynamic insertion, 2) indirect dynamic insertion, 3) direct static insertion, and 4) indirect static insertion. In a typical direct dynamic insertion method, user 114's browser sends an HTTP request message for a published web page 206 over data network 104. Responsive to receiving the request, web page 206 requests ad data from ad network service provider 102. The ads can be associated with an advertiser 112 or other merchants such as seller 204, for which advertiser 112 is an agent. Responsive to receiving the request message from published web page 206, ad network service provider 102 retrieves advertisement data associated with advertiser 112 from storage medium 202, including affiliate identification information. The retrieved advertisement data and affiliate identification information is sent from ad network service provider 102 to web page 206 over data network 104.

When the requested ads and accompanying affiliate identification information are delivered to web page 206, they can then be integrated with the content of web page 206. For instance, the ad can be displayed in a graphical and/or textual component of web page 206, such as an electronic ad 208, and the affiliate identification information embedded in the source code of the web page. The web page 206 is then served to user 114 over data network 104. When the user's browser clicks the electronic ad 208, the browser is routed, directly to the advertiser 112 or indirectly through ad network service provider 102.

In the indirect dynamic insertion method, user 114 sends an HTTP request for published web page 206, and published web page 206 is then served to user 114's browser with affiliate identification information embedded in the web page source code. A component of the source code instructs user 114's browser to fetch ad data. The user 114's browser then sends an HTTP request for the ad data to ad network service provider 102, and the service provider 102 responds with the requested ad data and the affiliate identification information.

In the direct static insertion method, rather than retrieving ad data responsive to user browser clicks, the published web page 206 is statically published with ad data and metadata, including affiliate identification information. Thus, in this method, responsive to an HTTP request message for published web page 206 from user 114's browser, the web page 206 can be immediately served in its static form. When user 114 clicks on ad 208, the user's browser is directed to advertiser 112. The indirect static insertion method is similar to the extent of serving web page 206 with ad data to user 114. However, in the indirect method, a user click on the displayed ad 208 is routed to ad network service provider 102, and then redirected to advertiser 112.

In an alternative embodiment of the present invention, the ad network service provider 102 is removed from system 200. Thus, in this implementation, publisher 106 contracts directly with advertiser 112, so advertiser 112 is bound to pay publisher 106 fees for clicks and/or sales received through publisher 106. Advertisement data can be provided from advertiser 112 to publisher 106, for instance, when an ad is to be displayed on web page 206. Alternatively, advertisement data from advertiser 112 can be stored in a storage medium locally accessible to publisher 106.

In FIG. 2, a user 114 typically accesses a publisher website or web page, such as web page 206, by searching for the publisher using an Internet search engine 116. Examples of search engine 116 include Google, Yahoo, and web log (“blog”) search and classification systems such as Technorati.com. One example of a suitable system, which can be provided to implement part or all of search engine 116, is described in commonly assigned and co-pending U.S. patent application Ser. No. 11/157,491, titled “ECOSYSTEM METHOD OF AGGREGATION AND SEARCH AND RELATED TECHNIQUES,” filed Jun. 20,2005, which is hereby incorporated by reference for all purposes.

In FIG. 2, using various search mechanisms such as keywords, tags, links, indexes, classification schemes, and others, the user computer 114 can execute a search on search engine 116, resulting in a search results page 210 provided to user 114 over data network 104 for display on a suitable display device. For instance, using a keyword search, user 114 identifies web page 206 as one of the results displayed on search results page 210. When user 114 clicks on a link to web page 206, web page 206, including ad 208, is displayed on a display screen for user 114.

In FIG. 2, when a user clicks on ad 208 of web page 206, the browser operated by user 114 is routed to a server operated by advertiser 112 for handling. For instance, advertiser 112 may display a purchase option for user 114, in which the advertised product or service in ad 208 can be purchased online. In another example, ad 208 links user 114 to a shopping web page or website operated by or on behalf of advertiser 112, in which the advertised product or service is displayed along with other products or services. Regardless of the handling of a click on ad 208, advertiser 112 is required to pay the ad network service provider 102 for the click, using the contractual pay-per-click arrangement described above.

For a publisher to be identified as providing ads on behalf of one or more advertisers, and paid accordingly, affiliate identification information, such as an identifying token, is generally built into the structure of their web documents. Affiliate identification information is also referred to herein as an “affiliate identifier” or “affiliate ID.” In one embodiment, the affiliate identification information identifies the publisher as an affiliate of ad network service provider 102. In another embodiment, in which ad network service provider 102 is not present, the affiliate identifier identifies the publisher as an advertising affiliate of one or more advertisers. In one embodiment, the request message from a publisher 106 to ad network service provider 102 requesting advertisement data includes the affiliate ID to register the provider web page 206 as the source of access, that is, the click linking to advertiser 112.

Affiliate identifiers are often embedded in the document source code of a publisher's network document, such as web page 206. For instance, embedding can occur directly in the value of a document anchor hypertextual reference, that is, a link. When the value of the link is a Uniform Resource Locator (URL), the path or query string can include the affiliate ID. Affiliate identification tokens may also be embedded in client side scripting code used to dynamically populate links, and record their context when clicked. Regardless of how the affiliate identification information is embedded, it can generally be derived from the document source code.

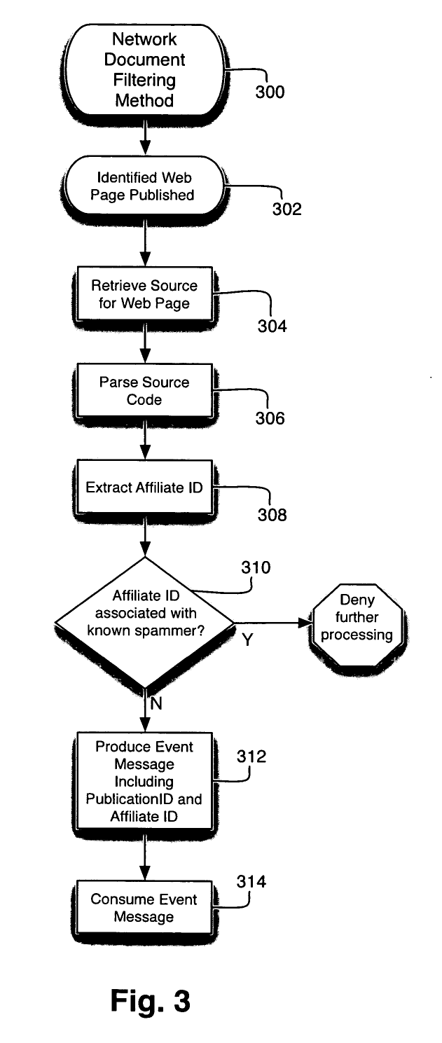

FIG. 3 shows a flow diagram of a network document filtering method 300, performed by spam identification engine 201 in cooperation with search engine 116, in accordance with one embodiment of the present invention. The method 300 is described with reference to system 200 of FIG. 2. Those skilled in the art should appreciate that method 300 can be implemented on other systems constructed in accordance with embodiments of the present invention, such as a system in which there is no ad network service provider 102. The method 300 is preferably repeated over one or more time periods, to gather network document publication data as described below.

In FIG. 3, method 300 begins in step 302 in which a web page 206 is produced by an identified publisher 106 having publication ID 203a. For instance, in FIG. 2, publisher 106 provides web page 206 on a website maintained by or on behalf of publisher 106. In one embodiment, search engine 116 implements a web “crawl” function, such as the crawling performed by search engines such as Google and Yahoo, and discovers the web page 206 from crawling the Internet, in step 302.

In another embodiment, search engine 116 is implemented as a tracking site, as described in U.S. patent application Ser. No. 11/157,491. In this embodiment, in step 302, the tracking site receives events notifications, e.g., pings, via data network 104 each time content is posted or modified at any of sites 106, 108, and 110. So, for example, if the content is a web log (“blog”) which is modified using a content management service such as Wordpress.com, when the content creator publishes the changes, code associated with the publishing tool makes a connection with the search engine 116 and sends an XML remote procedure call (XML-RPC) which identifies the name and URL of the blog. As will be understood, event notification mechanisms, e.g., pings, may be implemented in a wide variety of ways and may be generally characterized as mechanisms for notifying search engine 116 of state changes in dynamic content. Such mechanisms might correspond to code integrated or associated with a publishing tool (e.g., blog tool), a background application on PC or web server, etc.

In FIG. 3, in step 302, the search engine 116 may also be configured to periodically receive aggregated change information. For example, search engine 116 may acquire change information from other “ping” services. That is, other services, e.g., Blogger, exist which accumulate information regarding the changes on sites, which ping them directly. These changes are aggregated and made available on the site, e.g., as a changes.xml file. Such a file will typically have similar information as the pings described above, but may also include the time at which the identified content was modified, how often the content is updated, its URLs, and similar metadata.

In FIG. 3, in step 304, document parser 214 has acquired the updated content on web page 206, or is otherwise notified that search engine 116 has identified web page 206. In one embodiment, as shown in FIG. 2, parser 214 is integrated into crawler 212. In an alternative embodiment, parser 214 is implemented as a separate component or device. In another alternative embodiment, parser 214 is implemented as a component of spam identification engine 201. Those skilled in the art should appreciate that retrieving content, parsing, decomposition and analysis are separable functions and can be coupled and decoupled, depending on the desired implementation.

In FIG. 3, Responsive to acquisition of web page 206, spam identification engine 201 retrieves the source code for web page 206. The method then proceeds to step 306, in which the spam identification engine 201 parses the retrieved source code to identify an affiliate ID in the source code. One suitable parsing operation is to perform pattern matching on the text of web page document source code. For instance, affiliate identification tokens will contain the same text patterns and can be parsed with text tokenization, lexical analysis or regular expression types of pattern matching software. In step 308, once the pattern matching software identifies a match, the affiliate identification token can be extracted from the web page document source code by document parser 214. The extracted token can be monitored for recurrence within a time interval. Higher extraction rates for specific token instances may be indicative of abuse.

In FIG. 3, after extracting the affiliate ID in step 308, the document processing may be discontinued in step 310 if the affiliate ID matches one that is known to belong to a spammer. Otherwise document parser 214 produces an event message including the publication ID and extracted affiliate ID, in step 312. The event message is output on a suitable communications channel, such as a message bus, implemented with suitable software and/or hardware on spam identification engine 201. In step 314, the event message can be consumed off of the message bus. In one implementation, the publication ID and affiliate ID embedded in the event message are extracted and used to update network document publication data, as described herein. In one implementation, a “produce event message” process executing in spam identification engine 201 performs step 312, and a “consume event message” process executing in spam identification engine 201 performs step 314.

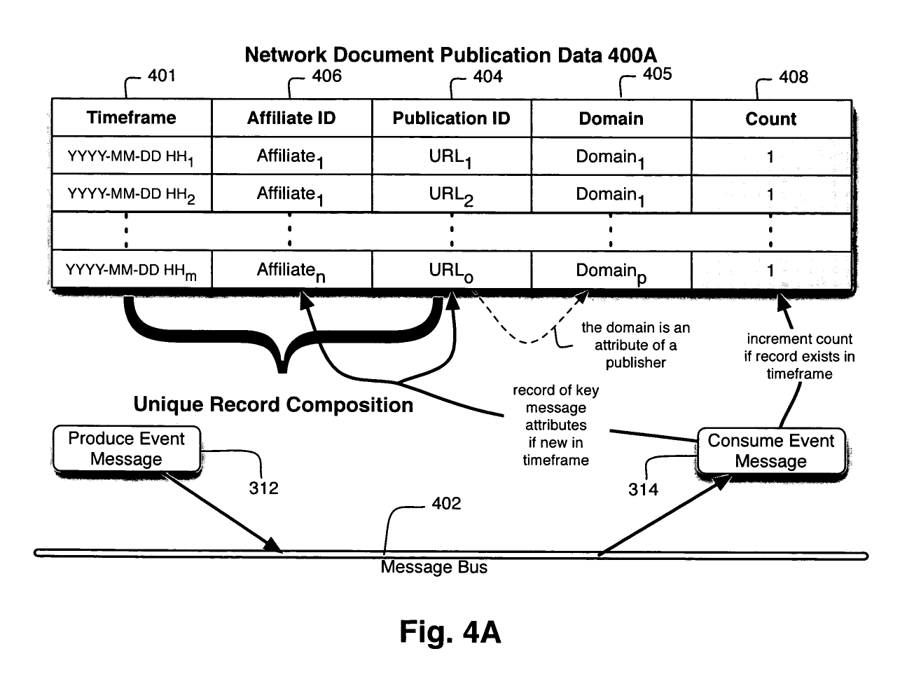

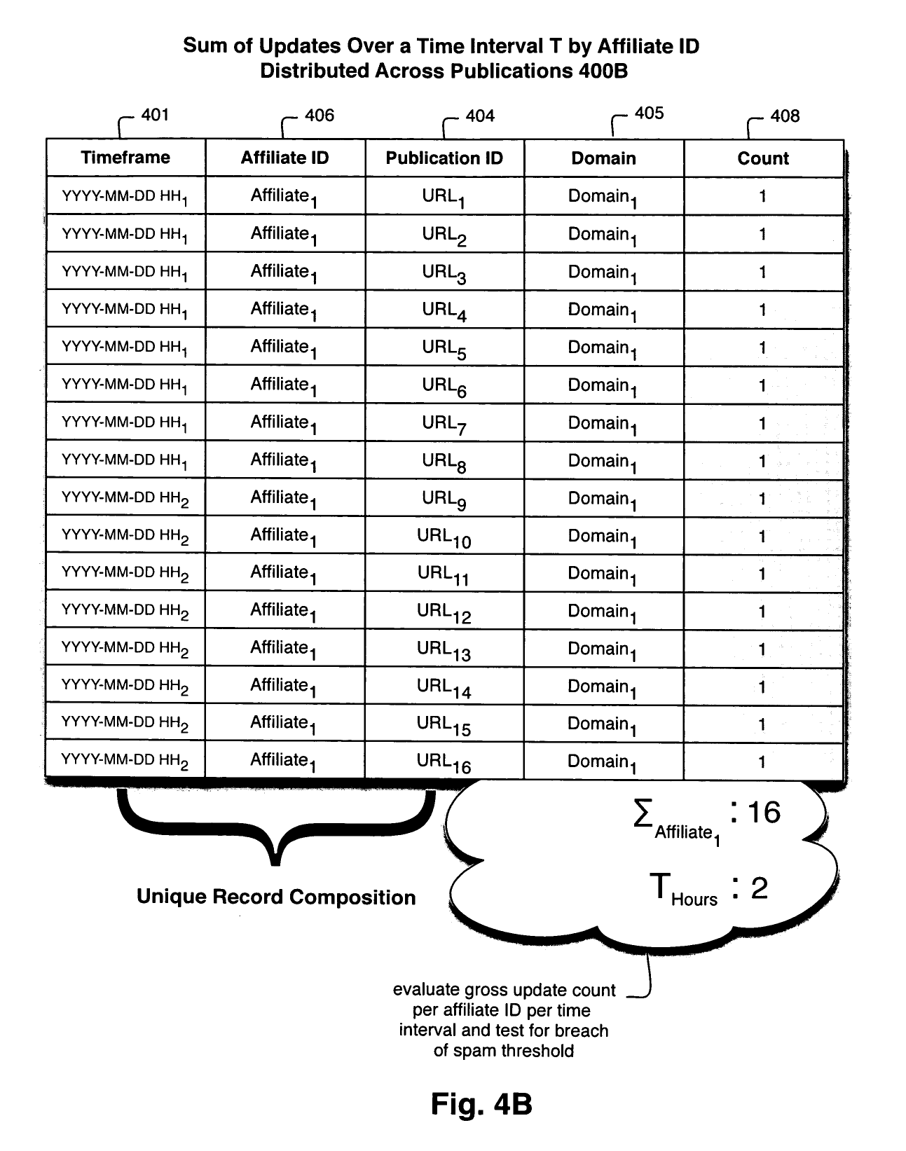

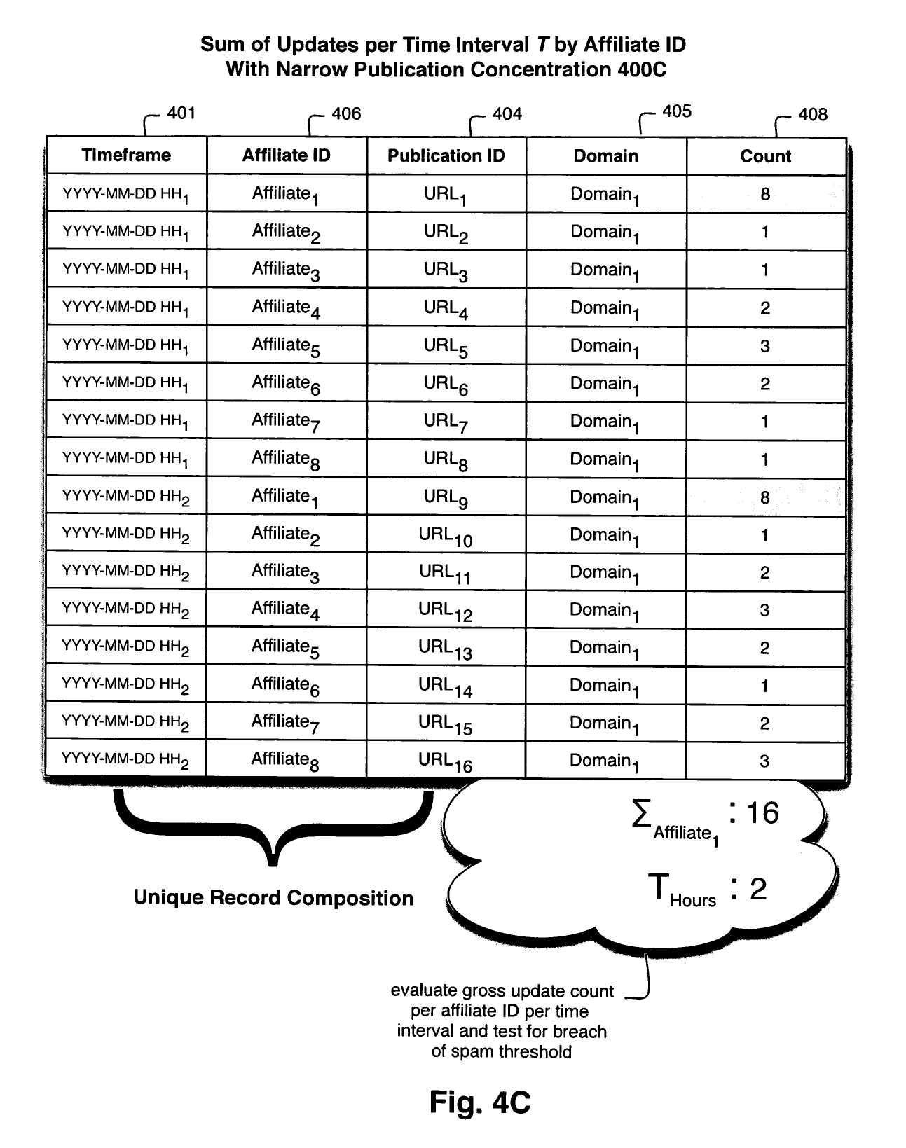

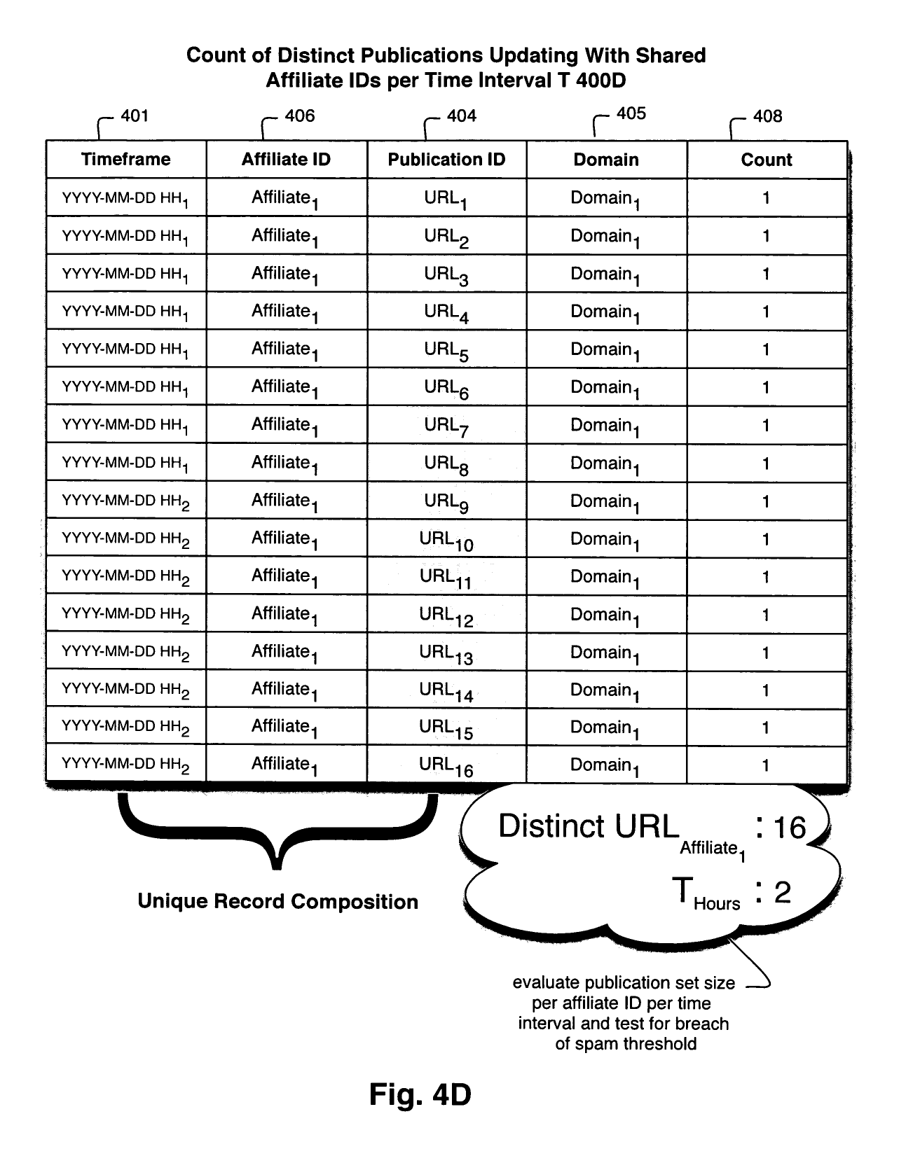

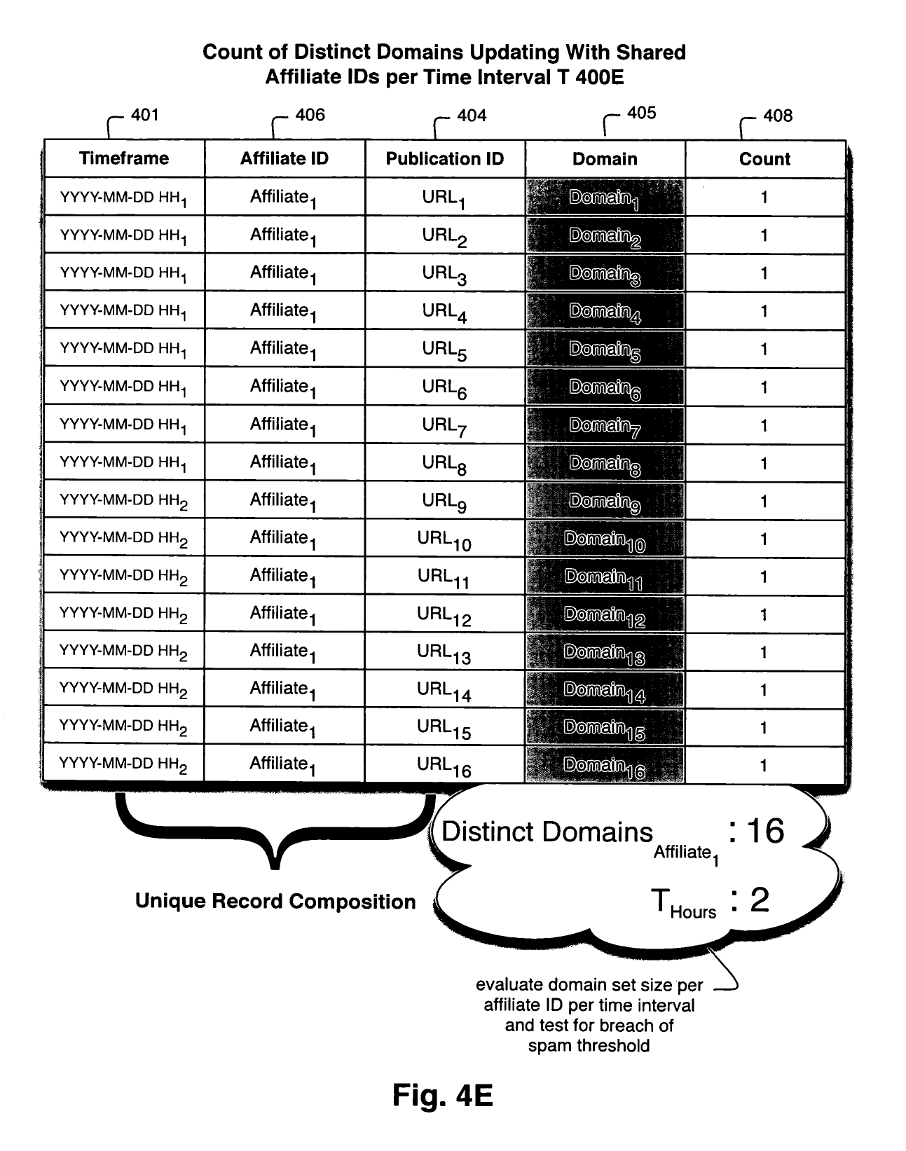

It is desirable to maintain data characterizing the publication of a network document such as web page 206. Thus, FIGS. 4A, 4B, 4C, 4D, and 4E provide examples of data structures and arrangements which can be constructed, maintained, and used by spam identification engine 201 to identify and classify network documents as spam, in accordance with embodiments of the present invention.

FIG. 4A shows a table of network document publication data 400A maintained by spam identification engine 201, according to one embodiment of the present invention. A message bus 402 receives output event messages produced in step 312 of FIG. 3, as method 300 repeats to identify and filter network document publications occurring over some timeframe. The event messages produced from repetitions of method 300 are consumed off of the message bus 402 in step 314, and the table 400A is updated accordingly with each consumed message.

In FIG. 4A, in one implementation, the table 400A is constructed to include five columns or groupings of data. In this implementation, a time interval or frame column 401 is maintained, with fields representing a series of time intervals 1-m. A list of publication IDs URL₁-URL₀ is maintained in column 404, listing publications identified in event messages consumed in step 314 during the designated time frame. A further column 405 of domains 1-p is maintained corresponding to the publication IDs of column 404. Generally, the domains identified in column 405 are attributes of the publications. A further column of data 406 identifies affiliate IDs extracted from event messages as they are consumed in step 314, for instance, during a designated time frame of 12 pm-1 pm. A count of update events, or messages consumed from message bus 402, associated with each affiliate ID for the designated time interval is maintained in column 408. This count of updates associated with each affiliate ID, also referred to herein as an “affiliate ID count,” is incremented as affiliate IDs are received from consumed event messages during the designated time frame.

FIGS. 4B and 4C show further table arrangements of network document publication data 400B and 400C, constructed according to embodiments of the present invention. Using table 400B, a sum of updates can be calculated over a time interval T by affiliate ID, distributed across publications. Table 400C shows a data structure for calculating a summation of updates over a time interval T by affiliate ID, with a narrow publication concentration.

In tables 400B and 400C, a column of affiliate IDs 406 is provided, identifying the affiliate IDs consumed in event messages in step 314 over designated time intervals. The second column 404 in tables 400B and 400C indicates publication IDs associated with the affiliate IDs consumed from the event messages. For instance, during hour 1, eight event messages identifying Affiliate₁ are received. However, each publication ID in the event messages identifies a different publication, namely URL₁-URL₁₆, as illustrated in FIGS. 4B and 4C. A count column 408 is incremented as event messages are consumed to count the total number of update events associated with a particular affiliate ID over a given timeframe. Thus, the count of updates associated with Affiliate₁ totals sixteen, with eight occurring during hour 1, and eight occurring during hour 2, as shown in FIGS. 4B and 4C. Counts of updates with other affiliate IDs are similarly maintained, as shown in FIG. 4C. As event messages are repeatedly consumed from message bus 402 in step 314, the associated publication ID column 404 and count 408 fields are updated. Using tables 400B and 400C, a gross update count per affiliate ID per time interval can be calculated, for instance, sixteen publications with Affiliate₁ over two hours, as shown in FIGS. 4B and 4C.

FIG. 4D shows a network document publication data table 400D, constructed according to another embodiment of the present invention. In FIG. 4D, a column of publication IDs 404 identifying URLs 1-16 embedded in event messages is maintained. Using data table 400D, a summation of all of the distinct URLs associated with a given affiliate ID can be calculated, as gathered over a time period T. This total count of distinct URLs represents a publication set size per affiliate ID per time interval. Thus, for example, in FIG. 4D, a total of sixteen distinct URLs for Affiliate₁ can be calculated over a period of two hours.

FIG. 4E shows a network document publication data table 400E, constructed according to another embodiment of the present invention, for counting distinct domains updated with shared affiliate IDs per time interval T. In FIG. 4E, a column of publication IDs 404 identifying URLs 1-16 embedded in event messages is maintained. In FIG. 4E, the column of associated domains 405 identifies sixteen different domains where the respective publications of column 404 are located. Using data table 400E, a summation of all of the distinct domains associated with a given affiliate ID can be calculated, as gathered over a time period T. This total count of distinct URLs represents a domain set size per affiliate ID per time interval. Thus, for example, in FIG. 4E, a total of sixteen distinct domains for Affiliate₁ can be calculated over a period of two hours.

Returning to FIG. 3, in step 306, the spam identification engine 201 parses the document source code of a web page to pattern match affiliate identifiers, such as tokens. For a given set of web sites “S” with a particular affiliate network identifier “A” during an interval “T,” the probability M that the pages on web site S are spam can be expressed as M(A)=S/T. When more than one web site S is updated with the same affiliate identification token A within a time interval T, there is a higher probability M of abuse. That is, a high number of unique sites using the same affiliate identifier increases the probability that the sites are publishing web spam content.

Spammers may also use a set of pages within a site. In this variation, the number of pages published per site within a time interval is monitored. That is, if a greater frequency of web page updates per interval is observed, a greater potential for abuse exists. In other words, extraordinary quantities of pages P bearing the same affiliate identification token A within a web site S during a time interval T raises the probability M of abuse. The probability M that the pages P are spam can be expressed as M(A)=P_{S}/T.

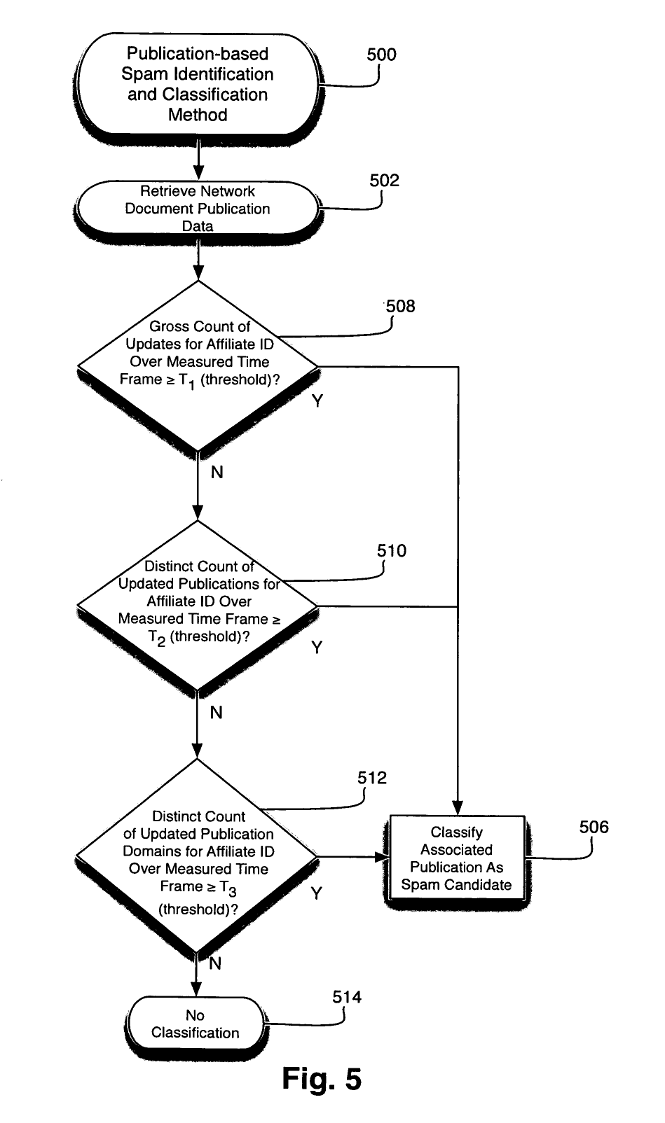

FIG. 5 shows a publication-based method 500 of identifying and classifying network documents as spam, performed in accordance with one embodiment of the present invention. The method 500 includes a number of tests, based on the probability principles described above, that indicate whether or not network documents are likely spam candidates. In step 502, the method 500 begins with retrieving network document publication data, for instance, as set forth in the Tables 400A-E of FIGS. 4A-E.

In one embodiment, spam identification engine 201 initially determines whether affiliate IDs 406 identified in one or more of tables 400A-E have been previously identified as used by illegitimate publishers, that is spammers. In one implementation, a list of previously identified spammers and their affiliate IDs, identified using the techniques described herein, is maintained. Thus, affiliate IDs 406 in the network document publication data are compared with affiliate IDs in the list. When the affiliate ID has previously been identified as illegitimate, further processing of the associated network documents can be stopped, as described above with respect to step 310 of FIG. 3.

In FIG. 5, after retrieving network document publication data in step 502, the method proceeds to step 508, in which spam identification engine 201 determines whether the affiliate ID count 408 for a designated affiliate ID 406 is greater than or equal to some threshold T1 over the designated time frame 401, for instance, using the data structures of FIGS. 4B and 4C, as described above. This spam test 508 evaluates the gross update count per affiliate ID per time interval. The threshold T1 can be set and adjusted based on experience, as desired for the particular implementation. When the count 408 exceeds the threshold T1, the method proceeds to step 506, as described above.

In FIG. 5, in step 508, when the count of affiliate IDs is less than the threshold T1, the method proceeds to step 510, in which spam identification engine 201 determines whether the count of updated publications with a given affiliate ID over a measured timeframe, for instance, as identified in table 400D of FIG. 4D, is greater than or equal to a threshold T2. This test 508 can be applied to evaluate the publication set size per affiliate ID per time interval. When the count exceeds or meets the designated threshold T2, in step 510, the method proceeds to step 506, as described above.

In FIG. 5, in step 510, when the threshold T2 is not met, the method proceeds to step 512 to determine whether the count of updated publication domains 405 associated with a given affiliate ID 406 over a measured timeframe, as identified in table 400E for instance, is greater than or equal to a threshold T3. This test 510 is applied to evaluate the domain set size per affiliate ID per time interval. When the count meets or exceeds the T3 threshold, the method proceeds to step 506. When the count is less than the threshold, the associated network documents are not classified as spam candidates, in step 514.

Those skilled in the art should appreciate that the thresholds T1-T3 described above can be set and adjusted as desired for the particular implementation, using a variety of techniques. For instance, a threshold can be administratively prescribed as a fixed number. Also, one or more of the thresholds can be automatically calculated and re-calculated by evaluating proportions and baselines established from historic data. Those skilled in the art should also appreciate that the tests in steps 508, 510, and 512 of FIG. 5 can be performed in any order, and they can be performed singularly or concurrently to identify and classify an associated network document as a spam candidate in step 506, depending on the desired implementation. In one implementation, the results of the tests in steps 508, 510, and 512 are weighted and combined according to a desired formula to provide a final or global indication of the likelihood of the associated network documents being spam. Other variations of method 500 are contemplated within the spirit and scope of the present invention.

As shown in FIG. 5, affiliate identification information that has an increased likelihood of abuse can be used to flag web sites and pages as spam candidates. The treatment of a spam candidate can include further evaluation, such as a content-based spam identification and classification method described below.

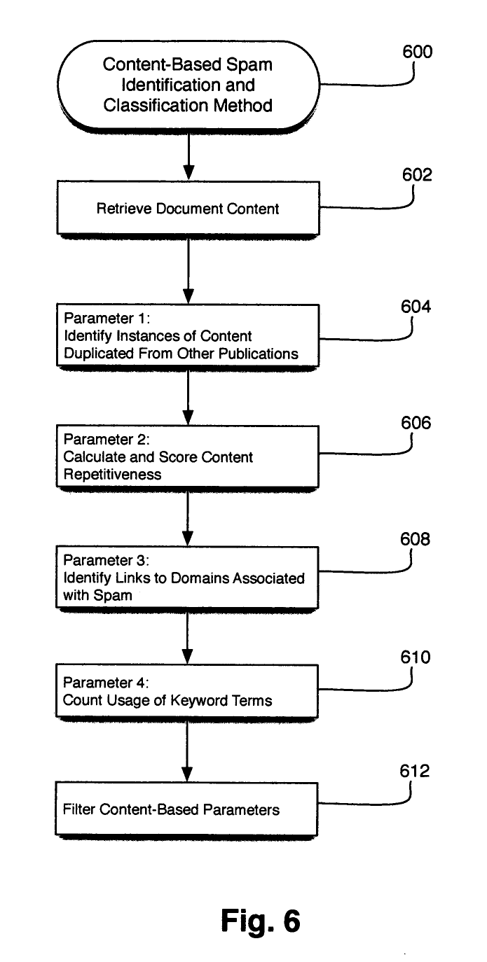

FIG. 6 shows a content-based method 600 of identifying and classifying network documents as spam, performed in accordance with one embodiment of the present invention. The method 600 begins in step 602 with retrieving the content of a network document, for instance, using a web crawl function, or responsive to a network ping, as described above. Several parameters can be calculated according to the retrieved document content.

In one implementation, in step 604, a first parameter is calculated by identifying instances of duplicated content from other publishers. For example, when content of a network document has been copied from other publishers, this suggests that the network document at issue may be spam. In one implementation, a count is maintained of the number of instances of copying, for instance, with respect to portions of text or other content on a web page, and/or with regard to the total number of other publishers from which content has been copied.

In FIG. 6, in step 606, a second parameter is calculated, scoring the repetitiveness of content in a given document. For example, a single word or a group of words can be copied and repeated throughout a document. The more repetitions, the more likely a spammer has stuffed the network document with illegitimate content. Thus, the score calculated for the amount of repetitiveness of content within the document can further indicate that the document is spam.

In FIG. 6, in step 608, the content of the network document at hand is screened to identify links to domains previously identified as being associated with web spam. For instance, a table can be maintained in which previously identified domains of spammers are listed. The links of a given network document can be compared with the domains set forth in the list. When the identified links are in the list, a flag is set indicating that the network document at issue is likely spam.

In FIG. 6, in step 610, the usage of keyword terms in the network document or associated with the network document can be counted. In some examples, the over-usage of certain keywords suggests spam. Thus, a list of keywords and their total count as appearing in a given web page is maintained. When certain keywords appear more than a predetermined number of times, this over-usage is a factor suggesting that the associated network document is spam.

In FIG. 6, in step 612, the gathered content-based parameters of steps 604, 606, 608 and 612 can be handled accordingly. In one example, weights are applied to the gathered parameters, and a summation or other suitable processing algorithm is performed to provide a final indication of the likeliness of the network document as being spam. Additional criteria can be applied, as contemplated within the spirit and scope of the present invention.

When the analysis described herein results in a determination that the spam candidate web sites and pages associated with the affiliate identification token are to be treated as spam, then a flag can be applied to the affiliate ID associated with spam sites and pages. The affiliate ID flag status can be maintained in the list of previously identified web spammers and associated affiliate IDS, described above. In one embodiment, a list of all known affiliate IDs and their flag status is stored and maintained in a database coupled to spam identification engine 201.

As the spam identification engine 201 extracts affiliate identification tokens from web pages, the engine can query the database to check if the token has been identified as one belonging to a spammer. The spam identification engine 201 can notify search engine 116 to decline to send web pages it finds with affiliate identification tokens flagged as spam to other systems for processing. By preventing further processing of web spam pages, embodiments of the invention can effectively thwart the spammer's intention of appearing in ranked search results.

Embodiments of the invention, including the methods, apparatus, engines, and devices described herein, can be implemented in digital electronic circuitry, or in computer hardware, firmware, software, or in combinations of them. Apparatus embodiments of the invention can be implemented in a computer program product tangibly embodied in a machine-readable storage device for execution by a programmable processor. Method steps of the invention can be performed by a programmable processor executing a program of instructions to perform functions of the invention by operating on input data and generating output.

Embodiments of the invention can be implemented advantageously in one or more computer programs that are executable on a programmable system including at least one programmable processor coupled to receive data and instructions from, and to transmit data and instructions to, a data storage system, at least one input device, and at least one output device. Each computer program can be implemented in a high-level procedural or object-oriented programming language, or in assembly or machine language if desired; and in any case, the language can be a compiled or interpreted language. Suitable processors include, by way of example, both general and special purpose microprocessors. Generally, a processor will receive instructions and data from a read-only memory and/or a random access memory. Generally, a computer will include one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM disks. Any of the foregoing can be supplemented by, or incorporated in, ASICs (application-specific integrated circuits).

It will be understood that the functions and processes described herein may be implemented in a variety of other ways. It will also be understood that each of the various functional blocks described may correspond to one or more computing platforms in a network. That is, the methods, functions, services and processes described herein may reside on individual machines or be distributed across or among multiple machines in a network or even across networks. It should therefore be understood that the present invention may be implemented using any of a wide variety of hardware, network configurations, operating systems, computing platforms, programming languages, service oriented architectures (SOAs), communication protocols, etc., without departing from the scope of the invention.

While the invention has been particularly shown and described with reference to specific embodiments thereof, it will be understood by those skilled in the art that changes in the form and details of the disclosed embodiments may be made without departing from the spirit or scope of the invention. In addition, although various advantages, aspects, and objects of the present invention have been discussed herein with reference to various embodiments, it will be understood that the scope of the invention should not be limited by reference to such advantages, aspects, and objects. Rather, the scope of the invention should be determined with reference to the appended claims.

What is claimed is:

1. A method for identifying and classifying a network document as a spam candidate, the method comprising:
retrieving the network document;
identifying affiliate identification information in the network document;
identifying one or more publications associated with the identified affiliate identification information;
determining publication data for the network document according to the identified affiliate identification information and the identified one or more publications;
determining that the publication data satisfies a condition indicative of spam; and
when it is determined that the publication data satisfies the condition, classifying the network document as a spam candidate.

2. The method of claim 1, wherein the publication data includes a time period, and a number of publications associated with the identified affiliate identification information during the time period.

3. The method of claim 2, wherein the condition includes a threshold number of publications.

4. The method of claim 1, wherein the publication data includes a count of one or more publication identifications associated with the identified affiliate identification information.

5. The method of claim 4, wherein the condition includes a threshold number of publication identifications.

6. The method of claim 1, further comprising:
identifying one or more domains associated with the identified affiliate identification information during a time period.

7. The method of claim 6, wherein the publication data includes a count of the one or more domains associated with the identified affiliate identification information.

8. The method of claim 7, wherein the condition includes a threshold number of domains.

9. The method of claim 1, wherein the publication data includes a list of affiliate identifiers associated with illegitimate publications.

10. The method of claim 9, wherein the condition includes matching the affiliate identification information to one of the affiliate identifiers on the list.

11. The method of claim 1, wherein identifying the affiliate identification information in the network document includes:
retrieving source code for the network document; and
parsing the source code for the affiliate identification information.

12. The method of claim 1, wherein determining the publication data for the network document according to the identified affiliate identification information and the identified one or more publications includes:
producing an event message including the affiliate identification information and a selected one publication; and
consuming the event message.

13. The method of claim 12, wherein consuming the event message includes:
updating a record of the publication data.

14. The method of claim 13, wherein the record is a table.

15. A data processing device for identifying and classifying a network document as a spam candidate, the data processing device comprising:
a communications interface capable of receiving the network document over a data network;
a processor coupled to the communications interface, the processor operatively coupled to:
i) identify affiliate identification information in the network document;
ii) identify one or more publications associated with the identified affiliate identification information;
iii) determine publication data for the network document according to the identified affiliate identification information and the identified one or more publications;
iv) determine that the publication data satisfies a condition indicative of spam; and
v) when it is determined that the publication data satisfies the condition, classify the network document as a spam candidate.

16. The data processing device of claim 15, wherein the publication data includes a time period, and a number of publications associated with the identified affiliate identification information during the time period.

17. The data processing device of claim 16, wherein the condition includes a threshold number of publications.

18. The data processing device of claim 15, wherein the publication data includes a count of one or more publication identifications associated with the identified affiliate identification information.

19. The data processing device of claim 18, wherein the condition includes a threshold number of publication identifications.

20. The data processing device of claim 15, the processor further operatively coupled to:
identify one or more domains associated with the identified affiliate identification information during a time period.

21. The data processing device of claim 20, wherein the publication data includes a count of the one or more domains associated with the identified affiliate identification information.

22. The data processing device of claim 21, wherein the condition includes a threshold number of domains.

23. The data processing device of claim 15, wherein identifying the affiliate identification information in the network document includes:
retrieving source code for the network document; and
parsing the source code for the affiliate identification information.

24. The data processing device of claim 15, wherein determining the publication data for the network document according to the identified affiliate identification information and the identified one or more publications includes:
producing an event message including the affiliate identification information and a selected one publication; and
consuming the event message.

25. The data processing device of claim 24, wherein consuming the event message includes:
updating a record of the publication data.

26. A computer program product, stored on a processor readable medium, comprising instructions operable to cause a data processing apparatus to perform a method for identifying and classifying a network document as a spam candidate, the method comprising:
retrieving the network document;
identifying affiliate identification information in the network document;
identifying one or more publications associated with the identified affiliate identification information;
determining publication data for the network document according to the identified affiliate identification information and the identified one or more publications;
determining that the publication data satisfies a condition indicative of spam; and
when it is determined that the publication data satisfies the condition, classifying the network document as a spam candidate.
